(19) United States
(12) Patent Application Publication
(10) Pub. No.: US 2010/0312646 A1
(43) Pub. Date: Dec. 9, 2010

(54) SYSTEM FOR SERVING ADVERTISEMENTS TARGETED TO GEOGRAPHIC AREAS OVER MOBILE DEVICES

(75) Inventors: Arvind Gupta, San Carlos, CA (US); Ashutosh Tiwari, Studio City, CA (US); Gopalakrishnan Venkatraman, Campbell, CA (US); Dominic Cheung, South Pasadena, CA (US); Stacy R. Bennett, Pasadena, CA (US); Douglas B. Koen, Austin, TX (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/963,029

(22) Filed: Dec. 21, 2007

(51) Int. Cl. G06Q 30/00

(52) U.S. Cl. 705/14.58

(57) ABSTRACT

A system is described for serving advertisements targeted to geographic areas over mobile devices. The system may include a processor, a memory and an interface being operatively connected. The memory may store a request associated with a mobile device, and an advertisement. The processor may be operative to communicate with the mobile device. The mobile device may be associated with a mobile carrier. The processor may receive the request associated with the mobile device and may determine a geographic location associated with the request. The processor may identify an advertisement, the advertisement being targeted to the geographic area and the mobile carrier. The processor may provide the identified advertisement to the mobile device.

### TECHNICAL FIELD

The present description relates generally to a system and method, generally referred to as a system, for serving advertisements targeted to geographic areas over mobile devices, and more particularly, but not exclusively, to serving advertisements over mobile devices targeted to the current geographic location of the mobile device.

### BACKGROUND

The mobile phone may be increasingly important as an information and content access device. Currently there may be twice as many mobile communication devices as personal computers. Mobile operators may be increasingly looking to high value data services as a way to overcome the continuing voice average revenue per user decline. Billions of dollars may be being spent globally on wireless licenses with billions more in investments in the pipeline for development of infrastructure and services by wireless service and content providers. Carriers may be introducing new data, content and multimedia services as a means of generating new revenue stream, reversing negative ARPU trends, retaining and attracting customers as well as increasing returns on investment, and extending and differentiating their service offering to consumers. The emergence of these wireless technologies may be creating unique opportunities for wireless carriers, advertisers and publishers to generate additional revenue streams through new and existing customers. As consumer adoption of wireless technology continues to increase, marketing via mobile devices may become an important part of all integrated data communications strategies.

Mobile advertising may play an important role in generating revenue in the mobile world. The mobile advertising market may grow as users become more comfortable with using their mobile phones as web access devices. The mobile phone may present advertisers with access to consumers everywhere the consumers take their mobile phones. However, the traditional model of targeting advertisements may be ineffective when targeting a user on a mobile device. Users may sporadically use their mobile devices to access the mobile web. The divergent uses of the mobile web may make it difficult to develop an accurate user profile for targeting a user's behavior. In addition mobile devices may have a limited amount of screen space. The screen of a mobile device may only allow for one advertisement to be displayed to a user at a time, greatly increasing the need for accurately serving relevant advertisements.

### SUMMARY

A system is disclosed for serving advertisements targeted to geographic areas over mobile devices. The system may include a processor, a memory and an interface. The memory may store a request associated with a mobile device, and an advertisement. The interface may be operatively connected to the memory and the processor and may be operative to communicate with the mobile device. The mobile device may be associated with a mobile carrier. The processor may be operatively connected to the memory and the interface. The processor may receive the request associated with the mobile device and may determine a geographic location associated with the request. The processor may identify an advertisement targeted to the geographic area and the mobile carrier. The processor may then provide the advertisement to the mobile device.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for serving advertisements targeted to geographic areas over mobile devices.

FIG. 2 is a block diagram of a simplified view of a network environment implementing the system of FIG. 1 or other systems for serving advertisements targeted to geographic areas over mobile devices.

FIG. 3 is a block diagram of an implementation of the system of FIG. 1 or other systems for serving advertisements targeted to geographic areas over mobile devices.

FIG. 4 is a flowchart illustrating operations of the system of FIG. 1, or other systems for serving advertisements targeted to geographic areas over mobile devices.

FIG. 5 is a flowchart illustrating operations of targeting advertisements to geographic areas in the system of FIG. 1, or other systems for serving advertisements targeted to geographic areas over mobile devices.

FIG. 6 is a flowchart illustrating operations of providing an advertisement targeted to a geographic area to a mobile carrier in the system of FIG. 1, or other systems for serving advertisements targeted to geographic areas over mobile devices.

FIG. 7 is a screenshot of a revenue generator's page for configuring targeting advertisements to geographic areas in the system of FIG. 1, or other systems for serving advertisements targeted to geographic areas over mobile devices.

FIG. 8 is an illustration of a mobile device displaying an advertisement targeted to a geographic area related to the content on the page in the system of FIG. 1 or other systems for serving advertisements targeted to geographic areas over mobile devices.

FIG. 9 is an illustration of a mobile device displaying an advertisement targeted to a geographic area unrelated to the content on the page in the system of FIG. 1 or other systems for serving advertisements targeted to geographic areas over mobile devices.

FIG. 10 is an illustration a general computer system that may be used in a system for serving advertisements targeted to geographic areas over mobile devices.

### DETAILED DESCRIPTION

A system and method, generally referred to as a system, relate to serving advertisements targeted to geographic areas over mobile devices, and more particularly, but not exclusively, to serving advertisements over mobile devices targeted to the current geographic location of the mobile device. The principles described herein may be embodied in many different forms.

The system may enable an advertising service provider to display to a user an advertisement targeted to the geographic area the user is currently located in. The advertisement may also be targeted to the mobile carrier providing mobile service to the user. The system may receive a geographic location from the mobile carrier, the mobile device, or by parsing the mobile request, and may display an advertisement targeted to the mobile carrier and targeted to, or related to, the geographic area. The advertising service provider may increase the likelihood of serving an advertisement of interest to a mobile user by serving an advertisement targeted to the current geographic location of the mobile user.

The system may enable an advertiser to target advertisements to a geographic area and a mobile carrier. The system may enable an advertiser to run a regional mobile promotional campaign by allowing the advertiser to target advertisements to a geographic area and a mobile carrier. The advertisements may be displayed on mobile messages, such as text messages, on a mobile web page, or on a mobile application, such as a mobile email reader.

An advertiser may use the system to target advertisements to users currently within the advertiser's facility, such as a brick and mortar store, or users currently in a particular section of the advertiser's store. For example the system may deliver an advertisement for a sale, via a text message or through a mobile web page, when a user enters the store of an advertiser. If the user walks through a particular section of the advertiser's store, such as the electronics section, the advertiser may be able to deliver an electronic advertisement. Alternatively or in addition an advertiser may use the system to serve advertisements to the user when the user enters a competitor's store. For example, an advertiser may target an advertisement to the geographic area containing a competitor's store. When a user enters the geographic area the system may display an advertisement of the advertiser to the user.

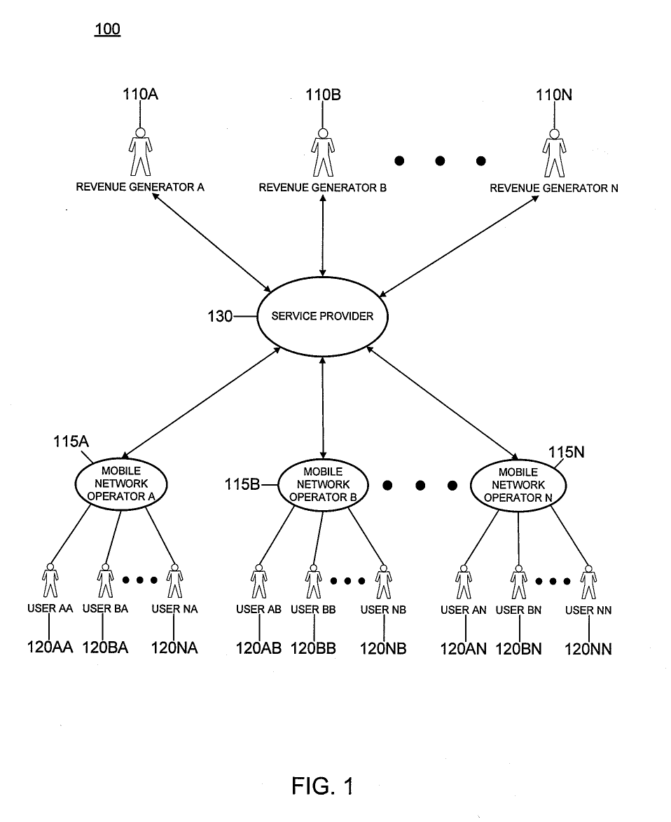

FIG. 1 provides a general overview of a system 100 for serving advertisements targeted to geographic areas over mobile devices. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more revenue generators 110A-N, such as mobile advertisers, a service provider 130, such as a portal or an advertising service provider, one or more mobile network operators (“MNOs”) 115A-N, more commonly referred to as mobile carriers, or simply carriers, and one or more users 120AA-NN, such as mobile subscribers or consumers. The service provider 130 may implement an advertising campaign management system incorporating an auction based and/or non-auction based advertisement serving system.

The revenue generators 110A-N may pay the service provider 130 to serve, or display, advertisements of their goods or services, such as on-line or mobile advertisements, to the users 120AA-NN, such as over mobile messaging, mobile web, the Internet, or generally any venue for displaying advertisements. The advertisements may include sponsored listings, banners ads, popup advertisements, mobile messages, or generally any way of attracting the users 120AA-NN to the web site or mobile site of the revenue generators 110A-N. The users 120AA-NN may utilize the services of the service provider 130 through web applications, mobile applications or standalone applications.

Alternatively or in addition the advertisements may also relate to the current location of the users 120AA-NN, such as a particular geographic area, or a particular store. The mobile devices of the users 120AA-NN may include a positioning system chip and may communicate location data representing the geographic location of the users 120AA-NN to the service provider 130, such as positioning coordinates, data describing the boundaries of a region, or other location descriptive data, such as a zip code. The positioning system may be a global positioning system (“GPS”), an EU Global Navigation Satellite System (“GNSS”), a Beidou positioning system a Galileo positioning system, a COMPASS positioning system, a GLONASS positioning system, an Indian Regional Navigational Satellite System (“IRNSS”), a QZSS positioning system, or generally any positioning system capable of determining the location of a device. The operating system of the mobile devices of the users 120AA-NN may communicate the location data directly to the service provider 130. Alternatively or in addition a mobile application running on the mobile devices, such as a mobile mapping application, may communicate the location data to the service provider 130. Alternatively or in addition the MNOs 115A-N may communicate the location data to the service provider 130. The MNOs 115A-N and/or the mobile devices may be able to determine an approximate location of the users 120AA-NN by triangulating the signals received by the mobile devices from the cell phone towers of the MNOs 115A-N.

Alternatively or in addition the service provider 130 may store user profiles for the users 120AA-NN. The user profiles may include a home address of the users 120AA-NN. The service provider 130 may be able identify a probable geographic location of a user AA 120AA by retrieving the home location of the user AA 120AA from the user profile of the user AA 120AA. Alternatively or in addition, a user AA 120AA may provide explicit location information that the service provider 130 may use to infer the probable geographic location of the user AA 120AA.

The service provider 130 may maintain a mobile portal and/or a web portal, such as a search site, where the service provider 130 may display advertisements of the revenue generators 110A-N to the users 120AA-NN. Alternatively or in addition the service provider 130 may be an advertising services provider. The service provider 130 may share revenue with the mobile network operators MNOs 115A-N of the users 120AA-NN for displaying advertisements of the revenue generators 110A-N via their mobile networks. Alternatively or in addition the service provider 130 may share revenue with individual publishers for displaying advertisements of the revenue generators 110A-N on their mobile and/or web sites. The service provider 130 may supply and API to the MNOs 115A-N enabling the MNOs 115A-N to request advertisements from the service provider 130.

The MNOs 115A-N may provide a mobile network to the users 120AA-NN which may provide a variety of services to the users 120AA-NN, such as the ability to send and receive phone calls, send and receive mobile messages, to access the internet and/or the mobile web, or generally any service that may be implemented on a mobile device. The MNOs 115A-N may store data describing the users 120AA-NN, such as billing addresses, call histories, messaging histories, or generally any data regarding the users 120AA-NN that may be available to the MNOs 115A-N.

The amount the revenue generators 110A-N may pay the service provider 130 may be based on one or more factors. These factors may include impressions, click throughs, conversions, and/or generally any metric relating to the advertisement and/or the behavior of the users 120AA-NN. The impressions may refer to the number of times an advertisement may have been displayed to the users 120AA-NN. The click throughs may refer to the number of times the users 120AA-NN may have clicked through an advertisement to a web site, mobile web site or mobile landing page of one of the revenue generators 110A-N, such as the revenue generator A 110A. The conversions may refer to the number of times a desired action was taken by the users 120AA-NN after clicking though to a web site of the revenue generator A 110A. The desired actions may include submitting a sales lead, making a purchase, viewing a key page of the site, downloading a whitepaper, and/or any other measurable action. If the desired action is making a purchase, then the revenue generator A 110A may pay the service provider 130 a percentage of the purchase.

The users 120AA-NN may be consumers of goods or services who may be searching for a business, such as the business of one of the revenue generators 110A-N. The users 120AA-NN may be searching for the internet presence of one of the revenue generators 110A-N, or the real world, or brick and mortar, presence of one of the revenue generators 110A-N. Alternatively or in addition the users 120AA-NN may be machines or other servers, such as a third party server. The users 120AA-NN may need a user identifier or identification (“user ID”) to access the services of the service provider 130. In order to obtain a user ID the users 120AA-NN may need to supply information describing themselves to the service provider 130, such as the home location, gender, and/or age of the users 120AA-NN, or generally any information that may be required for the users 120AA-NN to utilize the services provided by the service provider 130. The service provider 130 may collect user behavior data from the users 120AA-NN when they are logged in, such as queries searched for by the users 120AA-NN, links clicked on by the users 120AA-NN and/or any user interactions with the services provided by the service provider 130. The service provider 130 may also use cookies, such as a browser cookie, to collect user behavior data of users 120AA-NN who are not logged in or who are not otherwise identifiable.

The service provider 130 may serve advertisements relevant to collected user behavior data to the users 120AA-NN, via mobile messages, mobile web pages, or mobile applications. For example, if a user AA 120AA performed searches for sports topics, subscribed for sports alerts, or viewed sports related media or articles, the service provider server 130 may serve a sports related ad to the user AA 120AA with the alert. The revenue generators 110A-N may identify categories to associate their advertisements with, such as sports. Alternatively or in addition, the service provider server 130 may perform content matching on the advertisements of the revenue generators 110A-N and identified interests of the user AA 120AA, such as sports. The service provider 130 may serve advertisements directly to the users 120AA-NN, or the MNOs 115A-N, and/or other third party servers, may request advertisements from the service provider 130 to display to the users 120AA-NN.

Alternatively or in addition the service provider 130 may serve advertisements relevant to the current geographic location of the users 120AA-NN, such as the user AA 120AA. The service provider 130 may serve an advertisement of a revenue generator A 110A with a store or physical presence near the current geographic location of the user AA 120AA. The service provider 130 may serve an advertisement for an item of interest to the user AA 120AA located near the current geographic location of the user AA 120AA. For example, if a behavioral profile of the user AA 120AA indicates that the user AA 120AA likes sports, the service provider 130 may serve an advertisement for the local sports team to the user AA 120AA. If the user AA 120AA is physically inside a store of a revenue generator A 110A, the revenue generator A 110A may serve an advertisement related to a sale in the store. Alternatively or in addition when the user AA 120AA is physically inside the store of the revenue generator A 110A, a competitor to the revenue generator A 110A, such as the revenue generator B 110B may target an advertisement to the user AA 120AA.

In the system 100, the revenue generators 110A-N may interact with the service provider 130, such as via a web application. The revenue generators 110A-N may send information, such as billing, website or mobile site, advertisement information, and a geographic targeting area to the service provider 130 via the web application. The web application may include a web browser or other application such as any application capable of displaying web content. The application may be implemented with a processor such as a personal computer, personal digital assistant, mobile phone, or any other machine capable of implementing a web application.

The users 120AA-NN may also interact individually with the service provider 130, through the mobile network operators 115A-N, such as via a mobile phone or any mobile device capable of communicating with the mobile network operators 115A-N. The users 120AA-NN may interact with the service provider 130 via a mobile web based application, a mobile standalone application, or any application capable of running on a mobile device. The service provider 130 may communicate data to the revenue generators 110A-N over a network and to the users 120AA-NN over a network via the MNOs 115A-N. The following examples may refer to a revenue generator A 110A as an online advertiser or mobile advertiser; however the system 100 may apply to any revenue generators 110A-N who may desire to serve advertisements over mobile devices.

A revenue generator A 110A who is an mobile advertiser may maintain one or more accounts with the service provider 130. For each account the revenue generator A 110A may maintain one or more campaigns. For each campaign the revenue generator A 110A may maintain one or more listings. A listing may include a keyword, or a category, and one or more mobile message listings. Each listing may include an advertisement title, an advertisement description, a bid amount and a mobile site URL, if any. A listing may represent an association between a keyword, or a category, a mobile advertisement, a mobile carrier and a geographic area. The listing may also include an option to have the advertisement displayed to users over mobile messages. The revenue generators 110A-N may be able to specify demographic characteristics, such as age, gender, etc, they wish their advertisement to be targeted to. The revenue generators 110A-N may be able to specify a minimum number of mobile messages to have their advertisement attached to per month.

The revenue generator A 110A may be able to target a campaign, a group of listings, or an individual listing to one or more MNOs 115A-N and one or more geographic areas. The advertisement associated with the listing may only be displayed when the request for the advertisement originates from a device on the one of the identified mobile carriers and located within one of the identified geographic regions. The revenue generator A 110A may specify the MNOs 115A-N to target the listings to. In addition the revenue generator A 110A may identify a geographic region to target a listing. The geographic region may be identified by providing a zip code, the geographic coordinates or GPS coordinates defining the boundaries of an area, a city/state, using a graphical map tool to identify the boundaries of the area, or generally any method for identifying a geographic area.

If the revenue generator A 110A does not have a mobile site URL for the MNO A 115A, the revenue generator A 110A may still bid on a keyword for the MNO A 115A. In this case, the service provider 130 may dynamically create a “WAP ad.” The “WAP ad” may be an offer landing page containing the phone number of the revenue generator A 110A, the logo of the revenue generator A 110A and/or descriptive text detailing the products and services offered by the revenue generator A 110A. When a user AA 120AA clicks on the advertisement of the revenue generator A 110A who does not have a mobile site, the user AA 120AA may be taken to a page showing the phone number and/or logo of the revenue generator A 110A. The user AA 120AA may then use their mobile device to call the phone number of the revenue generator A 110A and complete their transaction. The data associated with the “WAP ad” may be stored in the advertisement title and/or the advertisement description fields.

The keywords may represent one or more terms that the revenue generator A 110A wishes to associate with their advertisement. If the keywords appear in a mobile message, a web search or a location near the current geographic location of the users AA 120AA, the advertisement of the revenue generator A 110A may be displayed to the user AA 120AA. The advertisement title may represent the data the revenue generator A 110A wishes to be displayed to a user AA 120AA. Alternatively or in addition, the advertisement description may represent the data the revenue generator A 110A wishes to be displayed to a user AA 120AA when the user AA 120AA receives a mobile message containing the keyword. The mobile site URL may represent the link the revenue generator A 110A wishes a user AA 120AA to be directed to upon clicking on the mobile advertisement of the revenue generator A 110A, such as the home page of the revenue generator A 110A. The bid amount may represent a maximum amount the revenue generator A 110A may be willing to pay each time a user AA 120AA may click on the mobile advertisement of the revenue generator A 110A or each time the mobile advertisement of the revenue generator A 110A may be shown to a user AA 120AA.

There may be some instances where multiple revenue generators 110A-N may have bid on the same keywords or geographic areas for one of the MNOS 115A-N. The service provider 130 may serve to the users 120AA-NN the advertisements that the users 120AA-NN may be most likely to click on. For example, the service provider 130 may include a relevancy assessment to determine the relevancy of the multiple mobile advertisements to the keywords and the geographic area. The more relevant a mobile advertisement may be to the keyword the more likely it may be that the user AA 120AA may click on the advertisement. A geographic area may be relevant to advertisements of the revenue generators 110A-N if the physical location of the revenue generators 110A-N is within the geographic area. Alternatively or in addition an advertisement may be relevant to a geographic area if the advertisement is for an item located within the geographic area.

Alternatively or in addition, the revenue generators 110A-N, may be able to select automatic geographic targeting. Automatic geographic targeting may automatically serve any advertisements of the revenue generators 110A-N relevant to the current geographic area of the user AA 120AA. The system 100 may make a determination as to the geographic area an advertisement relates to or is relevant to. For example, if the user AA 120AA is physically located within a certain radial distance of a revenue generator A 110A, the service provider 130 may display the advertisements of the revenue generator A 110A to the user AA 120AA.

In operation, one of the MNOs 115A-N, such as the MNO A 115A, may request an advertisement from the service provider 130. The MNO A 115A may request an advertisement for display to the user AA 120AA by making a call to an application programming interface (“API”) provided by the service provider 130. The MNO A 115A may supply information to the service provider 130 in order to allow the service provider 130 to return an advertisement of relevance. The information may include location data describing the geographic location of the user. The location data may be geographic coordinates, GPS coordinates, data defining the boundaries of a region, such as coordinates of a center point and a radial distance extending from the center point, or generally any data that may be used to describe the geographic location of a user. The MNO A 115A may retrieve the location data from a GPS chip on the mobile device of the user AA 120AA, or by triangulating the signal transmitted from the mobile device to one or more cell phone towers. In the case of a geographic location of varying altitude, such as a multi-story building, the MNO A 115A may supply the altitude of the user AA 120AA to the service provider 130. The altitude of the user AA 120AA may assist the service provider 130 in determining the location of the user AA 120AA within the multi-story building. Alternatively or in addition, an application running on the mobile device of the user AA 120AA may request an advertisement from the service provider 130. The application may provide location data to the service provider 130. Alternatively or in addition the service provider 130 may request the location data from the MNO A 115A or from a mobile application running on the mobile device. Alternatively or in addition the geographic location of the user AA 120AA may be communicated to the service provider 130 in the header of a request.

The service provider 130 may maintain a database of geographic data corresponding to a geographic region, such as a city, a state, a country, the entire planet, or generally any region. The service provider 130 may use the database to determine revenue generators 110A-N, or places advertised about by revenue generators 110A-N, located near the current geographic location of the user AA 120AA.

The information received by the service provider 130 with an advertisement request may be applied to existing client browser targeting mechanisms of the service provider 130. The service provider 130 may use any or all of the received information to target an advertisement, such as targeting the advertisement to the specific mobile device, the user AA 120AA, the time of the day, the location of the user, the source of the message, or generally using any of the information supplied by the MNO A 115A. The advertisement may be communicated back to the MNO A 115A. The MNO 115A may attach the advertisement to the mobile message or include the advertisement in a mobile web page, and communicate the advertisement to the user AA 120AA. The service provider 130 may store data regarding the user AA 120AA and the advertisement. The data may include the demographics of the user AA 120AA and whether the user AA 120AA clicked on the advertisement in the mobile message.

Alternatively or in addition, the MNOs 115A-N may display advertisements within the mobile applications of the users 120AA-NN. For example, the mobile messaging applications of the users 120AA-NN may have an ad slot where the MNOs 115A-N may display advertisements. The MNOs 115A-N may request a batch of advertisements for a given geographic area from the service provider 130 for display on the mobile applications of each of the users 120AA-NN. The MNOs 115A-N may communicate data relating to each of the individual users 120AA-NN to the service provider 130. The service provider 130 may use the data relating to each of the individual users 120AA-NN to retrieve advertisements relating to each of the users 120AA-NN. The service provider 130 may then communicate the batches of advertisements pertaining to the geographic area for each of the users 120AA-NN to the MNOs 115A-N. The MNOs 115A-N may then display the advertisements to the users 120AA-NN.

More detail regarding the aspects of auction-based systems, as well as the structure, function and operation of the service provider 130, as mentioned above, can be found in commonly owned U.S. patent application Ser. No. 10/625,082, filed on Jul. 22, 2003, entitled, “TERM-BASED CONCEPT MARKET”; U.S. patent application Ser. No. 10/625,000, file on Jul. 22, 2003, entitled, “CONCEPT VALUATION IN A TERM-BASED CONCEPT MARKET” filed on Jul. 22, 2003; U.S. patent application Ser. No. 10/625,001, filed on Jul. 22, 2003, entitled, “TERM-BASED CONCEPT INSTRUMENTS”; and U.S. patent application Ser. No. 11/489,386, filed on Jul. 18, 2006, entitled, “ARCHITECTURE FOR AN ADVERTISEMENT DELIVERY SYSTEM,” all of which are hereby incorporated herein by reference in their entirety. The systems and methods herein associated with ad campaign management may be practiced in combination with methods and systems described in the above-identified patent applications incorporated by reference.

More detail regarding the aspects of a mobile advertising auction-based systems, as well as the structure, function and operation of the service provider 130 as a mobile advertising provider, as mentioned above, can be found in commonly owned U.S. patent application Ser. No. 11/712,276, filed on Feb. 28, 2007, entitled, “SYSTEM FOR SERVING ADVERTISEMENTS OVER MOBILE DEVICES,” which is hereby incorporated herein by reference in its entirety. The systems and methods herein associated with mobile advertising campaign management may be practiced in combination with methods and systems described in the above-identified patent application incorporated by reference.

Furthermore, the service provider 130 may generate reports based on the data collected from the users 120AA-NN and communicate the reports to the revenue generators 110A-N to assist the revenue generators 110A-N in measuring the effectiveness of their mobile advertising campaigns in a geographic area. The reports may indicate the number of times the users 120AA-NN viewed a mobile advertisement of the revenue generators 110A-N, the number of times a mobile advertisement of the revenue generators 110A-N was clicked on by the users 120AA-NN, or generally any information useful to the revenue generators 110A-N.

Alternatively or in addition the reports may further segment the data by displaying the geographic location of the users 120AA-NN when the users 120AA-NN viewed or interacted with the advertisement. The reports segmenting the data by geographic areas may allow the revenue generators 110A-N to determine the effectiveness of their advertising campaigns in each geographic region. The revenue generator A 110A may be able to identify the level of detail they would like the geographic areas segmented into. For example, the reports may be segmented by country, by state, by city, or by geographic areas whose boundaries are identified by a revenue generator A 110A. There may be a separate report for each of the MNOs 115A-N the advertisement of the revenue generator A 110A was displayed on. The reports may also generally indicate any data that may assist the revenue generators 110A-N in measuring the effectiveness of their mobile advertising campaigns.

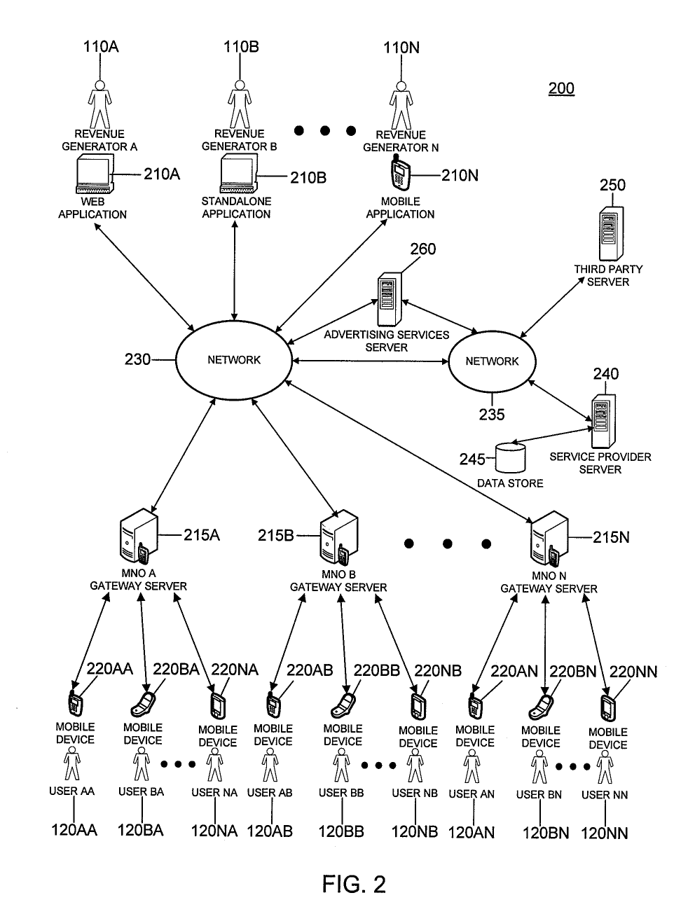

FIG. 2 provides a simplified view of a network environment implementing a system 200 for serving advertisements targeted to geographic areas over mobile devices. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 200 may include one or more web applications, standalone applications and mobile applications 210A-N, which may be collectively or individually referred to as client applications of the revenue generators 110A-N. The system 200 may also include one or more mobile applications, or mobile apps, which may be running on one or more mobile devices 220AA-NN. The system 200 may also include one or more MNO gateway servers 215A-N, a network 230, a network 235, a data store 245, the service provider server 240, a third party server 250, and an advertising services server 260.

Some or all of the advertisement services server 260, service provider server 240, and third-party server 250 may be in communication with each other by way of network 235 and may be the system or components described below in FIG. 10. The advertisement services server 260, third-party server 250 and service provider server 240 may each represent multiple linked computing devices. Multiple distinct third party servers, such as the third-party server 250, may be included in the system 200. The third-party server 250 may be an MNO gateway server 215A-N or a server associated with, or in communication with an MNO gateway server 215A-N.

The data store 245 may be operative to store data, such as data relating to interactions with the users 120AA-NN. The data store 245 may also store data describing a geographic area, such as a city, state, country, or planet. The data may include the names of places which are associated with location data, such as geographic coordinates. The location data may describe the geographic location of the places. The data store 245 may include one or more relational databases or other data stores that may be managed using various known database management techniques, such as, for example, SQL and object-based techniques. Alternatively or in addition the data store 245 may be implemented using one or more of the magnetic, optical, solid state or tape drives. The data store 245 may be in communication with the service provider server 240. Alternatively or in addition the data store 245 may be in communication with the service provider server 240 through the network 235.

The networks 230, 235 may include wide area networks (WAN), such as the internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The revenue generators 110A-N may use a web application 210A, standalone application 210B, or a mobile application 210N, or any combination thereof, to communicate to the service provider server 240, such as via the networks 230, 235. The service provider server 240 may communicate to the revenue generators 110A-N via the networks 230, 235, through the web applications, standalone applications or mobile applications 210A-N.

The users 120AA-NN may use a mobile application running on a mobile device 220AA-220NN, such as a mobile web browser, to communicate with the service provider server 240, via the MNO gateway servers 215A-N and the networks 230, 235. The service provider server 240 may communicate to the users 120AA-NN via the networks 230, 235 and the MNO gateway servers 215A-N, through the mobile devices 220AA-NN.

The web applications, standalone applications, mobile applications and mobile devices 210A-N, 220AA-NN may be connected to the network 230 in any configuration that supports data transfer. This may include a data connection to the network 230 that may be wired or wireless. Any of the web applications, standalone applications and mobile applications 210A-N, may individually be referred to as a client application. The web application 210A may run on any platform that supports web content, such as a web browser or a computer, a mobile phone, personal digital assistant (PDA), pager, network-enabled television, digital video recorder, such as TIVO®, automobile and/or any appliance capable of data communications.

The standalone applications 210B may run on a machine that may have a processor, memory, a display, a user interface and a communication interface. The processor may be operatively connected to the memory, display and the interfaces and may perform tasks at the request of the standalone applications 210B or the underlying operating system. The memory may be capable of storing data. The display may be operatively connected to the memory and the processor and may be capable of displaying information to the revenue generator B 110B. The user interface may be operatively connected to the memory, the processor, and the display and may be capable of interacting with a revenue generator A 110A. The communication interface may be operatively connected to the memory, and the processor, and may be capable of communicating through the networks 230, 235 with the service provider server 240, third party server 250 and advertising services server 260. The standalone applications 210B may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others.

The mobile application 210N may run on any mobile device which may have a data connection. The mobile applications 210N may be a web application 210A, a standalone application 210B, or a mobile browser. The mobile devices 220AA-NN may be one of a broad range of electronic devices which may include mobile phones, PDAs, and laptops and notebook computers. The mobile devices 220AA-NN may have a reduced feature set, such as a smaller keyboard and/or screen, and may be incapable of supporting a traditional web search. The mobile devices may have a GPS chip or other hardware device capable of determining the location of the mobile devices. Alternatively or in addition the mobile devices may execute an application capable of determining the location of the mobile devices, such as by triangulating a signal from the mobile device with cell phone towers or other signal receivers/transmitters.

The data connection of the mobile devices 220AA-NN may be a cellular connection, such as a GSM/GPRS/WCDMA connection, a wireless data connection, an internet connection, an infra-red connection, a Bluetooth connection, or any other connection capable of transmitting data. The data connection may be used to connect directly to the network 230, or to connect to the network 230 through the MNO gateway servers 215A-N.

The MNO gateway servers 215A-N may control the access the mobile devices 220AA-NN may have to the networks 230, 235. The MNO gateway servers 215A-N may also control the technology supporting the respective mobile devices 220AA-NN. This may affect aspects of the user experience, such as signal strength and availability, speed and billing mechanisms. For example, the MNO A gateway server 215A may only allow the users 120AA-NA access to content provided by partners of the MNO A 115A. Furthermore, the MNO gateway servers 215A-N may only allow users 120AA-NN access to data in a specific format, such as WML, XHTML, NTT DOCOMO IMODE HTML, or cHTML. Alternatively or in addition, the mobile devices 220AA-NN may only support one of the aforementioned formats.

The MNOs 115A-N may utilize various components to provide these services to the users 120AA-NN, such as network switching systems (“NSS”), mobile switching centers (“MSC”), mobile switching center servers (“MSC-S”), home location registers (“HLR”), authentication centers (“AUC”), short message service centers (“SMSC”), signal transfer points (“STP”), message service centers (“MSC”), or generally any component that may be utilized to provide the mobile services. The MNOs 115A-N may interface with one or more external short messaging entities (ESME), such as the third party server 250, which may connect to the MNOs 115A-N to send and/or receive mobile messages to the users 120AA-NN. The ESMEs may provide voicemail, web, email, or other services to the users 120AA-NN of the MNOs 115A-N.

The service provider server 240 may include one or more of the following: an application server, a data source, such as a database server, a middleware server, and an advertising services server. One middleware server may be a mobile commerce platform, such as the YAHOO! SUSHI platform, which may properly encode data, such as mobile pages or mobile advertisements, to the formats specific to the MNO gateway servers 215A-N. The service provider server 240 may co-exist on one machine or may be running in a distributed configuration on one or more machines. The service provider server 240 may collectively be referred to as the server. The service provider server 240 may receive requests from the users 120AA-NN and the revenue generators 110A-N and may serve mobile pages to the users 120AA-NN and web pages and/or mobile pages to the revenue generators 110A-N based on their requests.

The third party server 250 may include one or more of the following: an application server, a data source, such as a database server, a middleware server, and an advertising services server. The third party server 250 may co-exist on one machine or may be running in a distributed configuration on one or more machines. Alternatively or in addition, the third party server may be an ESME server. The advertising services server 260 may provide a platform for the inclusion of advertisements in pages, such as web pages or mobile pages. The advertisement services server 260 may be used for providing mobile advertisements that may be displayed to the users 120AA-NN.

The service provider server 240, the third party server 250 and the advertising services server 260 may be one or more computing devices of various kinds, such as the computing device in FIG. 10. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 210A may employ HTTP to request information, such as a web page, from a web server, which may be a process executing on the service provider server 240 or the third-party server 250.

There may be several configurations of database servers, application servers, middleware servers and advertising services servers included in the service provider server 240 or the third party server 250. Database servers may include MICROSOFT SQL SERVER, ORACLE, IBM DB2 or any other database software, relational or otherwise. The application server may be APACHE TOMCAT, MICROSOFT IIS, ADOBE COLDFUSION, YAPACHE or any other application server that supports communication protocols. The middleware server may be any middleware that connects software components or applications. The application server on the service provider server 240 or the third party server 250 may serve pages, such as web pages to the users 120AA-NN and the revenue generators 110A-N. The advertising services server may provide a platform for the inclusion of advertisements in pages, such as web pages. The advertising services server 260 may also exist independent of the service provider server 240 and the third party server 250.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

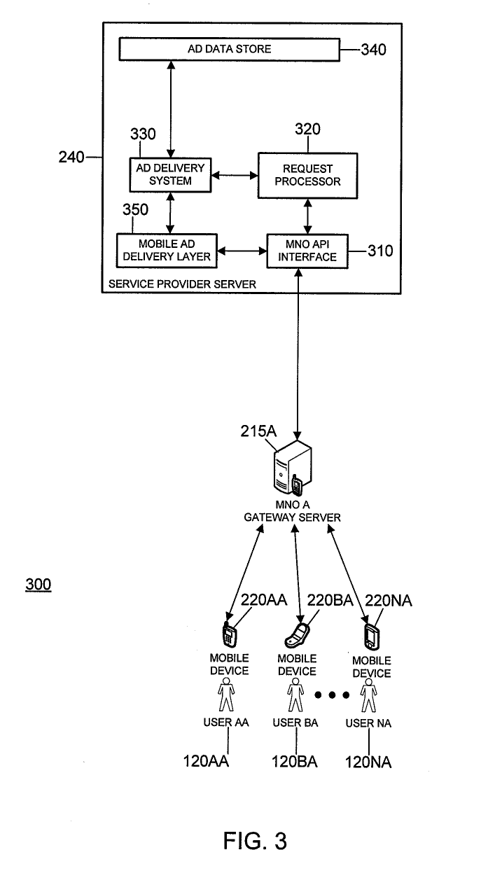

FIG. 3 illustrates a block diagram of an implementation of the system of FIG. 1 or other systems for serving advertisements targeted to geographic areas over mobile devices. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 300 may include the service provider server 240, the MNO A gateway server 215A, the mobile devices 220AA-NA, and the users 120AA-NA. The service provider server 240 may include an MNO API interface 310, a request processor 320, an ad delivery system 330, an ad data store 340, and a mobile ad delivery layer 350. The ad delivery system 330 and the ad data store 340 may be utilized by both web based and mobile based advertising.

In operation, the MNO A gateway server 215A may make an advertisement request to the service provider 240, via the MNO API interface 310. The request may include information describing one or more of the users 120AA-NA. The request may include location data describing the location of the one or more of the users 120AA-NA, data identifying the mobile carrier, and generally any additional information that may be used to target an advertisement. The MNO API interface 310 may communicate the request to the request processor 320. The request processor 330 may process the data from the MNO A gateway server 215A to format the data from the request into a standardized form used by the ad delivery system 320. The ad delivery system 320 may also supply ads for web browser based targeting as well as mobile based targeting. The processing of the data may include parsing the demographic information of the recipient, processing the location data into a standardized format, such as geographic coordinates, or a matrix of geographic coordinates. The request processor 320 may also determine a maximum length of the advertisement in order to comply with the space restrictions of the mobile devices 220AA-NA. Alternatively or in addition the MNO A gateway server 215A may supply the maximum allowable length for the advertisement.

The ad delivery system 330 may retrieve an advertisement from the ad data store 340 relating to the processed data. For example, if the MNO A 115A communicates the current location of the user BA 120BA to the service provider 130, the ad delivery system 330 may retrieve an advertisement related to the current geographic location of the user BA 120BA. The advertisement may be for an item located near the geographic location of the user BA 120BA, a revenue generator A 110A located near the geographic location of the user BA 120BA, an item matching the behavioral profile of the user BA 120BA and located near the geographic location, an item relating to the current mobile activity of the user BA 120BA located near the geographic location, or generally any combination of known targeting techniques combined with the geographic location of the user BA 120BA.

The revenue generators 110A-N may elect to participate in the geographic targeting system 100 and may identify a geographic area they wish their advertisements to be targeted to. Alternatively or in addition the revenue generators 110A-N may elect to participate in an automatic geographic targeting system which may automatically target their advertisements to users within a geographic area relating to the advertisement and/or the revenue generators 110A-N.

The ad delivery system 330 may then communicate the ad to the mobile ad delivery layer 350. The mobile ad delivery layer 350 may shorten the link, or URL, associated with the advertisement, such as by storing a mapping from the original link to a shortened link. A short link may be necessary to comply with the space requirements of the mobile device. The mobile ad delivery layer 350 may then communicate the text of the advertisement and the link to the MNO API interface 310. The MNO API interface 310 may then communicate the advertisement and link to the MNO A gateway server 215A. The MNO A gateway server 215A may attach the advertisement and the link to a mobile message, a mobile web page, an application running on one of the mobile devices 220AA-NA, or generally any method of displaying the advertisement to the users 120AA-NA.

The user BA 120BA may view the mobile advertisement on their mobile device 220BA. If the user BA 120BA selects the link the mobile web browser of the user BA 120BA may be directed to the link represented by the short link. The short link may direct the mobile browser of the user BA 120BA to the service provider server 240. The service provider server 240 may store data indicating that the user BA 120BA clicked on the mobile message advertisement and may then redirect the browser of the user BA 120BA to the link mapped to the short link.

Alternatively or in addition the service provider 130 may display a geographically targeted advertisement to one of the users 120AA-NA, such as the user AA 120AA. In this instance the service provider server 240 may request data describing the geographic location of the user AA 120AA from the mobile device 220AA, and/or the MNO A gateway server 215A. Alternatively or in addition the service provider server 240 may determine the location of the user AA 120AA based on the request of the user AA 120AA. For example, the user AA 120AA may search for “barbers in Chicago.” The service provider server 240 may determine that the user AA 120AA is located in Chicago, and may serve a geographically targeted mobile advertisement to the user AA 120AA related to Chicago. Alternatively or in addition the service provider 130 may access the user profile of the user AA 120AA to determine the home location of the user AA 120AA.

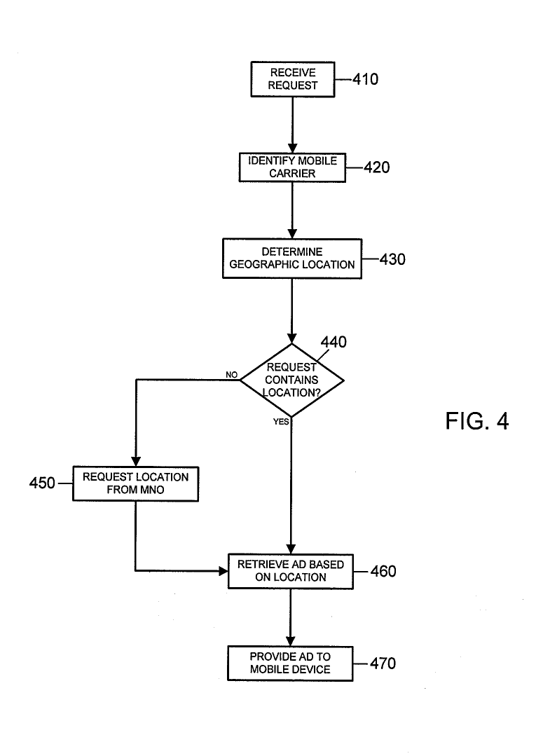

FIG. 4 is a flowchart illustrating operations of the system of FIG. 1, or other systems for serving advertisements targeted to geographic areas over mobile devices. At block 410 the service provider server 240 may receive a request for an advertisement targeted to a mobile carrier and a geographic area. The request may originate from a third party server 250, or one of the mobile devices 220AA-NN, such as the mobile device 220AA. At block 420 the service provider server 240 may identify the mobile carrier providing mobile service to the mobile device 220AA. Alternatively or in addition in the case of a roaming mobile device 220AA, the service provider server 240 may identify the home mobile carrier associated with the mobile device 220AA. The service provider server 240 may be able to determine the mobile carrier by parsing the request and/or parsing the header of the request.

At block 430 the service provider server 240 may determine the geographic location of the mobile device 220AA. The geographic location may have been communicated with the request to the service provider server 240, such as by a third party application running on the mobile device 220AA, or by the MNO A gateway server 215A. Alternatively or in addition the geographic location may be identifiable based on an item searched for by the user AA 120AA, such as “barbers near Chicago.” Alternatively or in addition the home geographic location of the user AA 120AA may be retrieved from the user profile of the user AA 120AA.

At block 440 the system 100 may determine whether the request contains information describing the location of the mobile device 220AA. If the request does not contain information describing the location of the mobile device 220AA the system 100 moves to block 450. At block 450 the service provider server 240 may request the geographic location of the mobile device 220AA from the MNO A 115A. The MNO A 115A may have access to data describing the cell phone tower the mobile device 220AA is communicating with. The MNO A 115A may also be capable of determining a geographic location of the mobile device 220AA by triangulating the signals communicated to/from the mobile device 220AA to a plurality of cell phone towers. These methods may not yield an exact location of the user AA 220AA, but a general area the user AA 220AA may be located in. Alternatively or in addition if the mobile device 220AA has GPS functionality, the MNO A 115A may have access to the GPS location of the mobile device 220AA.

Alternatively or in addition the service provider server 240 may request the location of the mobile device 220AA from the mobile device 220AA. The user AA 120AA may have installed a helper program provided by the service provider server 240, such as a mapping application, on the mobile device 220AA. If the mobile device 220AA has GPS functionality, or other functionality capable of determining the location of the mobile device 220AA, the helper program may be authorized to communicate data describing the location to the service provider server 240.

If at block 440 the request contains data describing the location of the mobile device 220AA, the system 100 may move to block 460. At block 460 the service provider server 240 may retrieve an advertisement targeted to the geographic location of the mobile device 220AA and the mobile carrier. At block 470 the service provider server 240 may provide the advertisement to the mobile device 220AA, such as by communicating the advertisement to the MNO A 115A, or by communicating the advertisement directly to the mobile device 220AA.

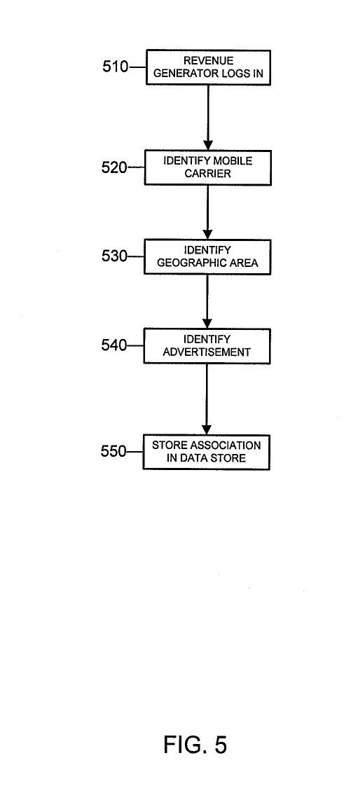

FIG. 5 is a flowchart illustrating operations of targeting advertisements to geographic areas in the system of FIG. 1, or other systems for serving advertisements targeted to geographic areas over mobile devices. At block 510 one of the revenue generators 110A-N, such as the revenue generator A 110A, may interact with the service provider server 240, such as by logging into a mobile advertising administration page. At block 520 the revenue generator A 110A may identify one or more mobile carriers to target an advertisement to. The advertisement may only be displayed when the mobile devices 220AA-NN of the one of the users 120AA-NN is communicating through the one or more mobile carriers.

At block 530 the revenue generator A 110A may identify a geographic location or a geographic area to target the advertisement to. The revenue generator A 110A may enter one or more of a city name, a state name, a zip code, geographic coordinates, GPS coordinates, or generally any method for identifying a geographic area. The advertisement may only be served to the users 120AA-NN when the users 120AA-NN are physically located within the geographic area.

At block 540 the revenue generator may identify an advertisement to display to the users 120AA-NN when the users 120AA-NN are connected to the identified carrier and within the identified geographic area. At block 550 the service provider server 240 may store the association between the mobile carrier, the geographic area and the advertisement in the data store 245.

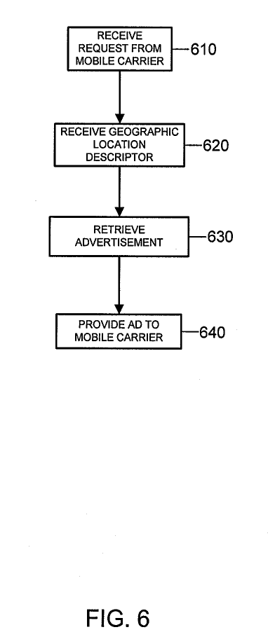

FIG. 6 is a flowchart illustrating operations of providing an advertisement targeted to a geographic area to a mobile carrier in the system of FIG. 1, or other systems for serving advertisements targeted to geographic areas over mobile devices. At block 610 the service provider server 240 may receive a request for an advertisement targeted to a geographic area from one of the MNOs 115A-N, such as the MNO A 115A. The request may be communicated to the service provider server 240 through the MNO API interface 310. At block 620 the service provider server 240 may receive a location descriptor describing the targeted geographic area from the MNO A 115A. The location descriptor may be geographic coordinates of the location or generally any method for describing a geographic area or location. At block 630 the service provider server 240 may retrieve an advertisement targeted to the geographic location and the MNO A 115A. At block 640 the service provider 240 may provide the advertisement to the MNO A 115A, such as by communicating the advertisement through the MNO API interface 310.

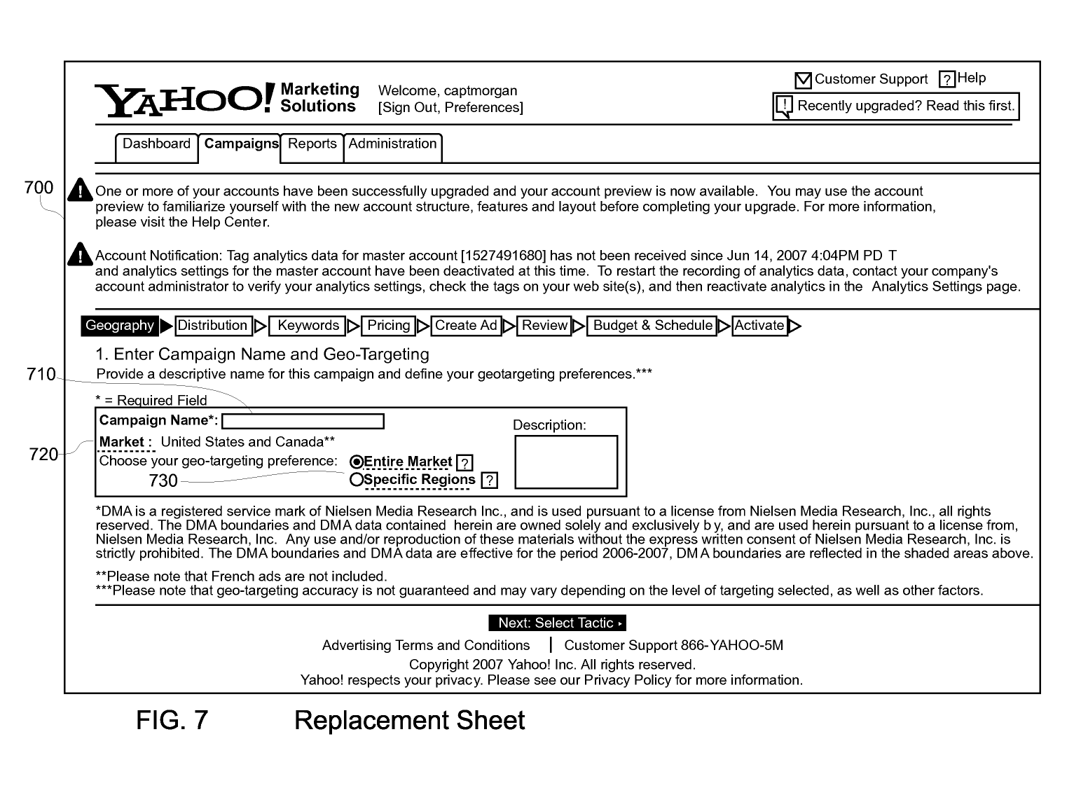

FIG. 7 is a screenshot of a revenue generator's page 700 for configuring targeting advertisements to geographic areas in the system of FIG. 1, or other systems for serving advertisements targeted to geographic areas over mobile devices. The page may include a campaign name field 710 a geographic market field 720 and a geographic market selector 730. The geographic market field 720 may display the currently selected geographic market to target the advertising campaign to. The advertising campaign may refer to one or more listings; each listing may be targeted to one or more mobile carriers.

In FIG. 7 the campaign is targeted to “United States and Canada.” Using the geographic market selector 730 the revenue generators 110A-N may be able to select whether to target the entire market or specific regions of the market. If the revenue generators 110A-N wish to target their advertising campaign to specific regions the system 100 may open an additional page, or window, which may allow the revenue generators 110A-N to specify the particular geographic regions, or areas, they wish to target the advertising campaign to.

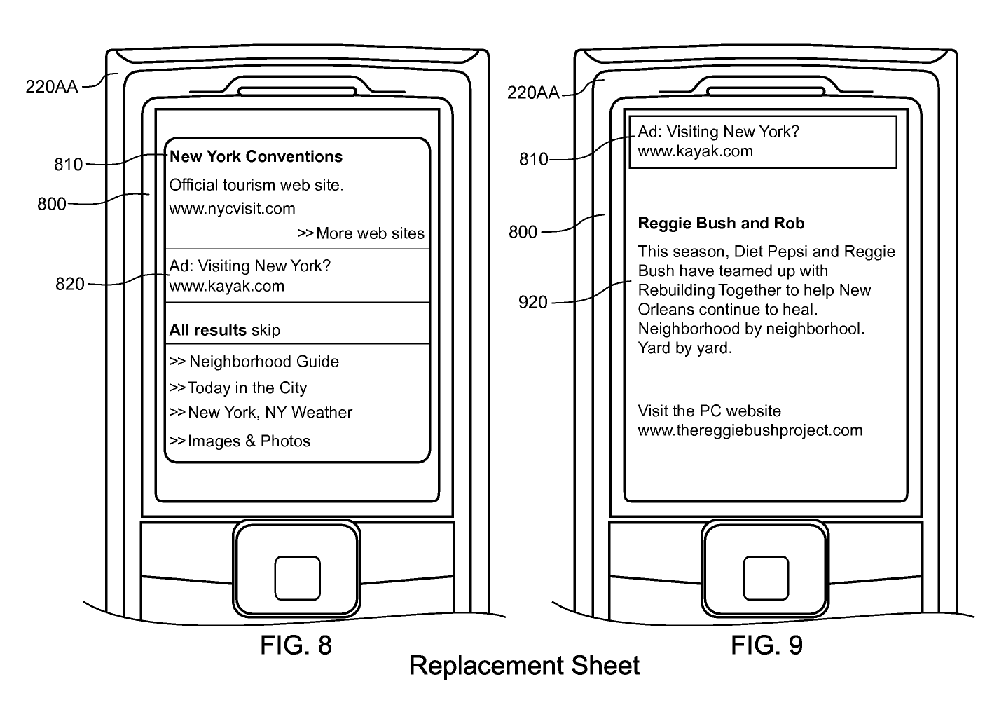

FIG. 8 illustrates a mobile device 220AA displaying an advertisement targeted to a geographic area related to the content on the page in the system of FIG. 1 or other systems for serving advertisements targeted to geographic areas over mobile devices. The mobile device 220AA may include a screen 800. The screen 800 may include a content 810, and an advertisement 820. In FIG. 8, the content 810 relates to a geographic location, that location being “New York.” When the user AA 120AA requested information on “New York Conventions” the service provider server 240 may have inferred from the request that the user AA 120AA is located in the New York region. The service provider server 240 may then have retrieved an advertisement targeted to the New York region, such as the advertisement 820.

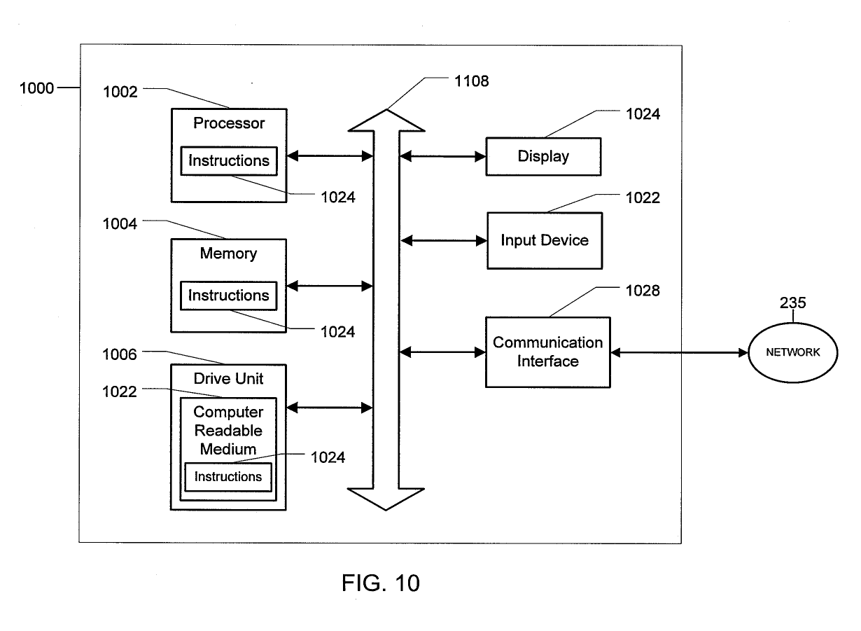

FIG. 9 illustrates a mobile device 220AA displaying an advertisement targeted to a geographic area unrelated to the content on the page in the system of FIG. 1 or other systems for serving advertisements targeted to geographic areas over mobile devices. The mobile device 220 AA may include a screen 800 and the mobile device 220AA may be physically located within the New York region. The screen 800 may include content 910 and an advertisement 810. The content 910 may be unrelated to a geographic area. The service provider server 240 may perform content matching on the content 910 to determine if the content relates to a geographic area. Alternatively or in addition the service provider 240 may traverse to links referenced by the content 910 to determine a geographic region related to the content 910.

The content 910 in FIG. 9 does not appear to directly relate to a geographic region, so the service provider server 240 may not be able to infer the location of the user AA 120AA from the content 910. In this case the service provider server 240 may request the geographic location of the user AA 120AA from the MNO A 115A or from the mobile device 220AA. Upon receiving the a descriptor of the geographic location the service provider server 240 may determine that the geographic location is New York. The service provider server 240 may then retrieve an advertisement 810 geographically targeted to New York, such as an advertisement for “Visiting New York?”.

FIG. 10 illustrates a general computer system 1000, which may represent a service provider server 240, a third party server 250, an advertising services server 260, one of the mobile devices 220AA-NN or any of the other computing devices referenced herein. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The computer system 1000 may include a set of instructions 1024 that may be executed to cause the computer system 1000 to perform any one or more of the methods or computer based functions disclosed herein. The computer system 1000 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1000 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 1024 (sequential or otherwise) that specify actions to be taken by that machine. In a particular embodiment, the computer system 1000 may be implemented using electronic devices that provide voice, video or data communication. Further, while a single computer system 1000 may be illustrated, the term “system” shall also be taken to include any collection of systems or sub-systems that individually or jointly execute a set, or multiple sets, of instructions to perform one or more computer functions.

As illustrated in FIG. 10, the computer system 1000 may include a processor 1002, such as, a central processing unit (CPU), a graphics processing unit (GPU), or both. The processor 1002 may be a component in a variety of systems. For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data. The processor 1002 may implement a software program, such as code generated manually (i.e., programmed).

The computer system 1000 may include a memory 1004 that can communicate via a bus 1008. The memory 1004 may be a main memory, a static memory, or a dynamic memory. The memory 1004 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 1004 may include a cache or random access memory for the processor 1002. Alternatively or in addition, the memory 1004 may be separate from the processor 1002, such as a cache memory of a processor, the system memory, or other memory. The memory 1004 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 1004 may be operable to store instructions 1024 executable by the processor 1002. The functions, acts or tasks illustrated in the figures or described herein may be performed by the programmed processor 1002 executing the instructions 1024 stored in the memory 1004. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 1000 may further include a display 1014, such as a liquid crystal display (LCD), an organic light emitting diode (OLED), a flat panel display, a solid state display, a cathode ray tube (CRT), a projector, a printer or other now known or later developed display device for outputting determined information. The display 1014 may act as an interface for the user to see the functioning of the processor 1002, or specifically as an interface with the software stored in the memory 1004 or in the drive unit 1006.

Additionally, the computer system 1000 may include an input device 1012 configured to allow a user to interact with any of the components of system 1000. The input device 1012 may be a number pad, a keyboard, or a cursor control device, such as a mouse, or a joystick, touch screen display, remote control or any other device operative to interact with the system 1000.

The computer system 1000 may also include a disk or optical drive unit 1006. The disk drive unit 1006 may include a computer-readable medium 1022 in which one or more sets of instructions 1024, e.g. software, can be embedded. Further, the instructions 1024 may perform one or more of the methods or logic as described herein. The instructions 1024 may reside completely, or at least partially, within the memory 1004 and/or within the processor 1002 during execution by the computer system 1000. The memory 1004 and the processor 1002 also may include computer-readable media as discussed above.

The present disclosure contemplates a computer-readable medium 1022 that includes instructions 1024 or receives and executes instructions 1024 responsive to a propagated signal; so that a device connected to a network 235 may communicate voice, video, audio, images or any other data over the network 235. The instructions 1024 may be implemented with hardware, software and/or firmware, or any combination thereof. Further, the instructions 1024 may be transmitted or received over the network 235 via a communication interface 1018. The communication interface 1018 may be a part of the processor 1002 or may be a separate component. The communication interface 1018 may be created in software or may be a physical connection in hardware. The communication interface 1018 may be configured to connect with a network 235, external media, the display 1014, or any other components in system 1000, or combinations thereof. The connection with the network 235 may be a physical connection, such as a wired Ethernet connection or may be established wirelessly as discussed below. Likewise, the additional connections with other components of the system 1000 may be physical connections or may be established wirelessly. In the case of a service provider server 240, a third party server 250, an advertising services server 260, the servers may communicate with users 120AA-NN and the revenue generators 110A-N through the communication interface 1018.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 1022 may be a single medium, or the computer-readable medium 1022 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 1022 may include a solid-state memory such as a memory card or other package that houses one or more non-volatile read-only memories. The computer-readable medium 1022 also may be a random access memory or other volatile re-writable memory. Additionally, the computer-readable medium 1022 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method of serving advertisements targeted to geographic areas over mobile devices, comprising:
receiving a request associated with a mobile device, wherein the mobile device is associated with a mobile carrier;
determining a geographic location associated with the request;
identifying an advertisement targeted to the geographic area and the mobile carrier of the mobile device; and
providing the advertisement to the mobile device.

2. The method of claim 1 wherein determining a geographic location associated with the request further comprises receiving a descriptor of the geographic location from the mobile carrier.

3. The method of claim 1 wherein determining a geographic location associated with the request further comprises retrieving a descriptor of the geographic area from the search request.

4. The method of claim 1 wherein determining a geographic location associated with the request further comprises receiving a descriptor of the geographic location from the mobile device.

5. The method of claim 1 wherein determining a geographic location associated with the request further comprises:
identifying a user profile associated with the request; and
retrieving the geographic location from the user profile.

6. A method of targeting an advertisement to a geographic area, comprising:
providing an interface enabling an advertiser to identify a keyword, a mobile carrier, a geographic area and an advertisement;
associating the advertisement with the mobile carrier, the geographic area and the keyword; and
providing the advertisement to a mobile device associated with the mobile carrier when a user located within the geographic area uses the mobile device to search for the keyword.

7. The method of claim 6 wherein associating the advertisement to the mobile carrier, the geographic area and the keyword further comprises associating a bid amount with the keyword, the mobile carrier and the geographic area for the advertisement.

8. The method of claim 7 wherein the bid amount comprises an amount paid by an owner of the advertisement when the advertisement is displayed on the mobile device.

9. The method of claim 6 wherein the interface comprises a web page.

10. The method of claim 6 wherein the mobile device is in communication with the mobile carrier.

11. A method of providing advertisements targeted to geographic areas to mobile carriers, comprising:
receiving a request for an advertisement from a mobile carrier for display on a mobile device;
identifying a descriptor of a geographic location associated with a physical location of the mobile device;
retrieving an advertisement associated with the descriptor of the geographic location and the mobile carrier; and
providing the advertisement to the mobile carrier for display on the mobile device.

12. The method of claim 11 wherein identifying the descriptor of the geographic location associated with the mobile device further comprises receiving the descriptor of the geographic location from the mobile carrier.

13. The method of claim 11 wherein identifying the descriptor of the geographic location associated with the mobile device further comprises receiving the descriptor of the geographic location from the mobile device.

14. The method of claim 13 wherein the descriptor comprises a set of coordinates and the coordinates are identified by a positioning system.

15. The method of claim 11 wherein the mobile device comprises a mobile phone.

16. A system for serving advertisements targeted to geographic areas over mobile devices, comprising:
a memory to store a request associated with a mobile device and an advertisement;
an interface operatively connected to the memory to communicate with the mobile device, wherein the mobile device is associated with a mobile carrier; and
a processor operatively connected to the memory and the interface the processor for running instructions, wherein the processor receives the request associated with the mobile device, determines a geographic location associated with the request, identifies an advertisement targeted to the geographic area and the mobile carrier, and provides the advertisement to the mobile device.

17. The system of claim 16 wherein the interface is further operative to receive a descriptor of the geographic location from the mobile carrier, and the processor is further operative to determine the geographic location from the descriptor.

18. The system of claim 16 wherein the processor is further operative to retrieve a descriptor of the geographic area from the search request, and determine the geographic location from the descriptor.

19. The system of claim 16 wherein the interface is further operative to receive a descriptor of the geographic location from the mobile device, and the processor is further operative to determine the geographic location from the descriptor.

20. The system of claim 16 wherein the processor is further operative to identify a user profile associated with the request, retrieve the geographic location from the user profile, and determine the geographic location from the descriptor.
